(19) United States
(12) Patent Application Publication
(10) Pub. No.: US 2005/0091104 A1
(43) Pub. Date: Apr. 28, 2005

(54) Savemore

(76) Inventor: Daniel M. Abraham, Kenner, LA (US)

Correspondence Address: DAN ABRAHAM, 308 Pellerin Dr., Kenner, LA, 70065, US

(21) Appl. No.: 10/440,620

(22) Filed: May 19, 2003

Related U.S. Application Data
(63) Continuation of application No. 10/286,932, filed on Nov. 4, 2002.

(51) Int. Cl. G06F 17/60

(52) U.S. Cl. 705/14

(57) ABSTRACT

An electronic Storefront (website approach) provided by the Inventor on the Internet, where specific brands, advertisers or retailers are provided proprietary departments and access (online Stores and display space) to promote any variety of product incentives, i.e. coupons, rebates, discounts etc. . . . , which can be target-marketed online to specific regions. Consumer relationship data is key to brands and retailers and may be obtained directly through the online Storefront utilizing the Inventor's interactive invention—$AVEMORE and its sister approach—rewards+. The additional development of the initial invention, $AVEMORE with its rewards+ approach, utilizes consumer surveys, brand questions, or loyalty card participation to help brands better market their products and to automatically reward consumers for participation. This invention allows the visitor to directly respond and be automatically rewarded for responding immediately through this new interactive program. The consumer can automatically upgrade the coupon value/amount selected by the reward amount provided by the Brand for specific demographic or behavioral data required. Additionally the Brand has immediate access to the consumer responses and this data, in real time, accessible through the back end database of the online Storefront.

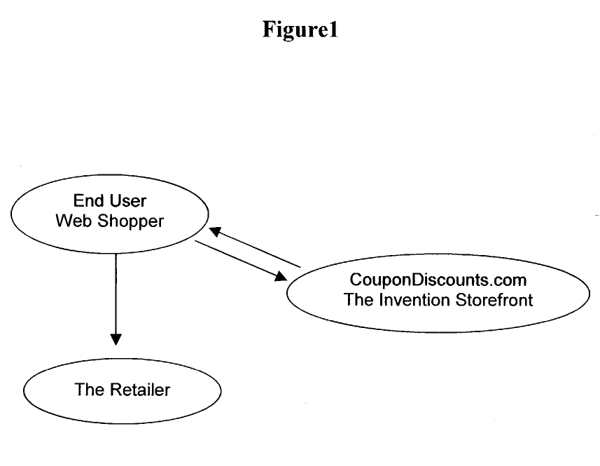

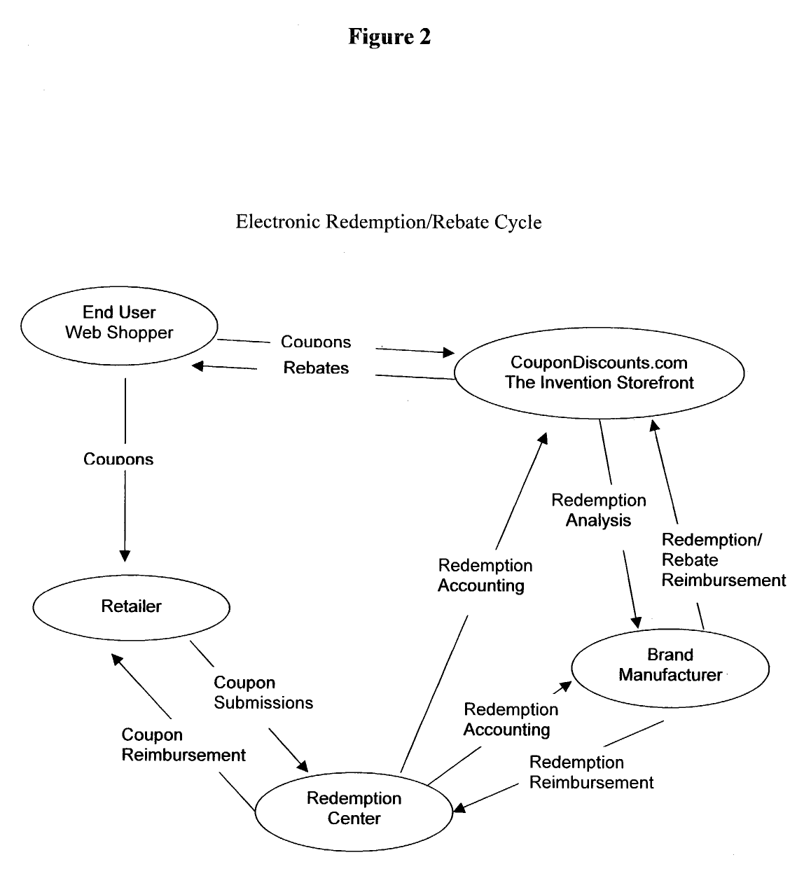

### FIELD OF THE INVENTION

### BACKGROUND OF THE INVENTION

With the variety of coupon and rebate sites popping up on the Internet, the web promises to be the brand-marketing vehicle of the future. Consumer Relationship Marketing (CRM) is a major component of a brands marketing, today. The psychographics and the demographics are vital components of brand marketing strategy.

The Brand Storefront to showcase and distribute coupons online is valuable but greatly enhanced by the $AVEMORE approach. Brands can provide product incentives (coupons or rebates) automatically online and give an even greater product discount if the shopper agrees to provide additional marketing information. This information may be in the form of opinions or specific questions, or loyalty card informations and identification provided directly online by the consumer, through the $AVEMORE vehicle. The shopper's responses are provided through the vehicle and the coupon upgrade is made upon submission of the requested information to the brand through the vehicle.

Additionally, loyalty or reward cards are very effective in motivating consumption and driving traffic to stores. This invention allows Retailers to provide coupon incentives and increase those incentives automatically with these new developments. The only requirement is participation in the Retailers program. Participation requirements are at the discretion of the Retailer.

The upgraded amount of the discount is automatically provided on the coupon offer and the dynamic bar code reflects the increase with an appropriate changed bar code to include the new offer code for the upgrade.

The Internet provides a terrific promotion resource with its speed and distribution ability but manufacturers have major issues with Web-based, printable incentive offers.

Package goods manufacturers have grave concerns regarding consumer data and this type of information is difficult and expensive to obtain through conventional methods of polling, sampling and surveying. Conventional approaches and existing inventions do not adequately address these concerns.

### SUMMARY OF THE INVENTION

The Internet seems to be ideally suited to assist in the exiting distribution dilemma of conventional brand marketers utilizing printed coupons. Utilizing the World Wide Web brand target-marketing to the masses is possible and affordable, regardless of the product, the locale or the prospect. Consumer relationship data is vital, as is development of loyalty programs and rewards to drive product movement and stimulate sales. The Invention provides a more affordable and cost/time efficient vehicle to accomplish brand and retailer marketing goals.

The Invention submitted, redefines target marketing, couponing and automatic upgrading of incentives. In the preferred embodiment, the Invention provides an electronic means for Brands and Retailers to display incentive offers in an online Storefront providing consumers the ability to control the amount of the promotion and the amount of information they are willing to provide, based on their participation in the new developments . . . $AVEMORE, with rewards+, promises to be one of the most dynamic consumer relationships tools online, due to its flexibility and consumer-centric approach.

The present invention is a continuation of the prior invention submitted in 2002. It will also be appreciated by those skilled in the art that variations and modifications may be made without departing from the spirit and scope of this invention.

1. An electronic, online Storefront approach provided to brand manufacturers and advertisers to target market specific incentive offers to specific regions, which also provides consumer relationship information vital to brand marketing through $AVEMORE—the invention.
I claim that specific online departments are issued to contracting brands and advertisers (online stores).
These departments are actually display areas controlled by the online Stores, hosted on the online Storefront.
Each Store's department is proprietary.
A variety of Stores may participate on the Storefront, and can provide an infinite number of items or categories.
Access into each department is gained through confidential passwords and login codes established and maintained by the Stores.
The Stores produce and submit their own offers to be displayed in their departments, showcased on the Inventor's Internet website.
The Stores has the ability to maintain their own departments and their own displays.
The Stores determine how many offers are to made available daily;
The Stores determine what regions are to receive what incentives.
Incentive offers may be national, regional or local, in scope.
I claim that each offer displayed by a Store may contain indigenous information:
The Store name;
The item or brand name
The value of the incentive;
Disclaimers and modifiers for the incentive;
The origin of the incentive by zip code;
I claim that the incentives displayed in the Stores are viewed and selected by end users/web shoppers.
The incentives are free to the end user;
Are available twenty-four hours a day, seven days a week;
Viewable and printable by the end user, at their discretion;
Are printed on the end user's printer.
I claim that each printed incentive is identified and maintained in the proprietary back end database, by the Storefront.
I claim that the printed incentive offers may contain items referenced above as well as the following:
Demographic information provided by the end user (web shopper) i.e. name, date of birth, sex, marital status, and other personal information.
Bar codes; An indigenous identification number or tracking code, which is logged into the Storefront's database for tracking and rebate purposes.
I further claim that the Storefront's database maintains all necessary information regarding the Stores, their departments, displays, links, rebates and customer accounts.
I claim that Activity Reports on incentive activity are available to the Stores though the Storefront's proprietary, backend database and software.
Activity reports provide the brands and advertisers tracking capability:
Where each item is displayed in their Store:
How many web shoppers saw the display (impressions);
How many web shoppers actually viewed the incentive offer;
How many web shoppers actually selected and printed out incentive offers;
How many incentives offers each the web shoppers actually selected and printed out;
Where the web shoppers are based;
Where the incentives were provided and redeemed;
From what regions web shoppers came;
What was the heaviest concentration of activity and when;
How large their loyalty base is on their Storefront.
I claim that these reports may be viewed online or printed out by the Store.

2. Identification and elimination of fraudulent submissions, as well as the automatic electronic rebates are accomplished by:
Tracking of impressions and print out activity for the incentives displayed by the Stores, and submitted to redemption facilities;
Indigenous identification numbers are printed on every incentive offer printed out through the Storefront.
Proprietary software is utilized at the redemption level to track activity on packaged goods as well as to determine rebate eligibility;
Information is retrieved at the time of the scanning the offers and accumulated as [symbol] .
The system comparatively scans the data accumulated for duplicates.
The data extracted from the scan is accumulated, interpreted and Stored by the Storefront for use by the Stores.

3. Coupon offers upgrades are automatically provided by $aveMore and its affiliate approach rewards+for consumer participation in surveys or loyalty programs. Online coupons are provided to consumers through the storefront. The invention provides for coupon offers to be increased or upgraded if the consumer or individual downloading the offers answers consumer relationships (CRM) questions or maintains a loyalty card or rewards card, provided by participating Retail stores.
By entering the pin or identification number of the loyalty card or by responding to the Consumer Relationships Marketing) CRM questions, the E-shopper can have his coupon offer increased by whatever amount is provided by the Brand or the retailer, through the coupon storefront.
The shopper receives the full value for the regular offer and has the ability to increase the amount of the discount by complying with the terms and conditions of the $AVEMORE or rewards+ or other names for the invention upgrade.
I claim that the $AVEMORE coupon upgrade can be used by brands in any variety of consumer promotions methods to provide demographic information and psychographic data as well. The brand is in complete control of what is asked through the survey and what the reward is. And the reward is totally contingent of the completion and submission of the information requested by the brand.
